(19) United States
(12) Patent Application Publication
(10) Pub. No.: US 2008/0313103 A1
(43) Pub. Date: Dec. 18, 2008

(54) SYSTEM FOR IDENTIFYING LOWEST COST PRESCRIPTION

(75) Inventors: Frank Burns, Sarasota, FL (US); Phil St. John, Sarasota, FL (US); Ramin Kouzehkanani, Bradenton, FL (US)

Correspondence Address: GIFFORD, KRASS, SPRINKLE,ANDERSON & CITKOWSKI, P.C, PO BOX 7021, TROY, MI, 48007-7021, US

(73) Assignee: Genuity Group, LLC

(21) Appl. No.: 12/139,785

(22) Filed: Jun. 16, 2008

Related U.S. Application Data
(60) Provisional application No. 60/943,929, filed on Jun. 14, 2007.

(51) Int. Cl. G06F 17/30

(52) U.S. Cl. 705/400; 707/104.1; 707/E17.058

(57) ABSTRACT

A computer software system that provides a requester and a physician with information on available cost savings for therapeutic equivalents to a patient's medication is disclosed. The computer software system can include an information-gathering template, a system administrator module, a search engine, a database and a message delivery module. The information-gathering template can be accessible by a requestor that is paying for the patient's medication and have an input field for accepting a medication name. The system administrator module can receive the medication name from the information-gathering template and instruct the search engine to search the database for a cost associated with the medication name, any therapeutic equivalents to the medication name and their respective cost.

### CROSS-REFERENCE TO RELATED APPLICATIONS

This application claims priority of U.S. Provisional Patent Application Ser. No. 60/943,929 filed Jun. 14, 2007, which is incorporated herein by reference.

### FIELD OF THE INVENTION

This invention relates generally to a system for identifying the lowest cost medical prescription and more specifically, to a computer software system for providing a requester and a physician with information on available cost savings for therapeutic equivalents to a patient's medication.

### BACKGROUND OF THE INVENTION

Prescription medicine can be very expensive and places financial burdens and hardships on many patients. The majority of Americans over the age of 50 take prescription medications on a regular basis. Americans over the age of 65 average over 4 different prescribed medications on a daily basis. Patients cannot always afford the proper dosage prescribed by the physician and seek alternative ways to cut the dosage or reduce prescription cost by other means. However, patients may not take the time or can be too embarrassed to discuss the cost of medications with their doctor and the doctor may not know or be aware of the comparison of cost factors for safe equivalent same class medications.

In an effort to provide medication selection guidance at the time of a prescription event, efforts have been made to provide a system and methods for aiding a pharmacist, physician and the like in prescribing lower cost medications. However, heretofore systems and methods have been complicated and do not provide a computer software system that is user friendly to a requestor and yet effective in providing the cost savings of using an equivalent medication. In addition, heretofore systems have included a patient's history, a patient's medical records, a patient's allergies, and the like, thereby increasing the cost of its use since such data input can be time and cost consuming. Therefore, an improved computer software system that provides available cost savings to a patient or other entity while also providing the same information to the patient's treating physician would be desirable.

### SUMMARY OF THE INVENTION

A computer software system that provides a requester and a physician with information on available cost savings for therapeutic equivalents to a patient's medication is disclosed. The computer software system can be in the form of an online portal that includes an information-gathering template, a system administrator module, a search engine, a database and a message delivery module. The information-gathering template can be accessible by a requestor that is paying for the patient's medication, have an input field for accepting a medication identifier and prompt the requester to enter the medication identifier along with other relevant patient information. The system administrator module can receive the medication identifier (hereafter referred to simply as “medication”) from the information-gathering template and instruct the search engine to search the database for a cost associated with the medication, any therapeutic equivalents to the medication and their respective cost. The search engine can search the database according to the instructions from the system administrator module and thereafter send any results and/or findings back to the system administrator module. It is appreciated that the database contains a list of medications, the class for tie medication, a standard dosage amount per time and a cost per standard dosage. After the system administrator module has received the results and/or findings of the search engine, it can make a determination as to whether or not the respective cost of any therapeutic equivalents to the medication is less than the cost of the medication and create a report as a function of the results. The system administrator module can also instruct the message delivery module to deliver the report to the requester and the physician. The message delivery module can deliver the report to the requestor and the physician using any number of report delivery systems such as facsimile, email, regular mail and the like.

In some instances, the report is in the form of a printable HTML web page, whereas in other instances, the report is in the form of an email, facsimile and the like. In addition, the information-gathering template can be a web-based HTML screen that accepts input from an individual using a computer connected to the Internet.

A process for providing a requester and a physician with information on available cost savings for therapeutic equivalents to a patient's medication is also disclosed. The process includes providing a computer software system as described above and then having the requester perform a number of tasks. For example, the requestor can log onto the computer software system and thereafter enter a patient name, a medication for the patient and a physician's name for the patient into the information-gathering template. The requester can also request a report comparing the cost of the medication to a cost of any therapeutic equivalents identified in the database. The system administrator module instructs the search engine to search the database and identify a cost associated with The medication, search the database and identify any therapeutic equivalents to the medication, and send the cost associated with the medication and any identified therapeutic equivalents with their respective cost back to the system administrator module. After the search engine has performed the relevant tasks, the system administrator module can make a determination as to whether or not the respective cost of one or more of the therapeutic equivalents is less than the cost of the medication, calculate such a difference over an extended period of time for which the medication is to be administered and create a report illustrating such differences. The system administrator module then instructs the message delivery module to deliver the report to the requestor and the physician.

### BRIEF DESCRIPTION OF THE DRAWINGS

FIG. 1 is a schematic illustration of an embodiment of the present invention;

FIG. 2 is a schematic illustration of the information-gathering template shown in FIG. 1;

FIG. 3 is a schematic illustration of the system administrator module shown in FIG. 1;

FIG. 4 is a schematic illustration of the database shown in FIG. 1; and

FIG. 5 is a schematic illustration of the message delivery module shown in FIG. 1.

### DETAILED DESCRIPTION OF THE INVENTION

A computer software system for providing a requester and a physician with information on available cost savings for therapeutic equivalents to a patient's medication is disclosed. As such, the present invention has utility as a computer software system and process for reducing the cost of health care.

The computer software system can be used by a variety of entities illustratively including patients, employers, third party administrators (TPA), physicians, pharmacists, nurses and the like. The system can be used at anytime by the above mentioned entities and can permit an inquiry and produce results for current, future and/or historical management of medication costs. The system can also operate independently of other software systems, database systems and the like, or in the alternative, be integrated with other medical systems to share patient and prescription information, health records, etc. In addition, the system can afford for requestors to create and update individual accounts, provide information to the requester and/or physician as to where a medication prescription should be filled based on reported cost savings and/or automatically contact and recommend the system to other potential requesters such as fellow employees, family members, friends and the like.

The computer software system can identify same class equivalent medication options and provide cost saving comparisons. In providing cost saving comparisons, the system can include its own index for calculating cost savings for consumers and can provide flexible customized/tailored indexing for requesters such as employers, TPA's and the like, that may have contracted pricing for medications. In addition the computer software system can be in the form of a “Software As A Service” (SAAS) and in which the system delivers a service. As such, requesters can access and use the system without having to install, integrate and/or manage any software. Furthermore, the system affords for a requester to generate and receive information, such as a cost savings report, and determine if and/or who should receive such information. For example, a patient using the system can elect whether to print a report and/or have the report sent directly to their physician. In the alternative, an employer using the system can elect whether or not to send a cost savings report to an employee and/or the employee's physician.

The computer software system can include an information-gathering template that is accessible by a requester and has an input field for accepting a medication identifier, such as a medication name, a medication number and the like (hereafter referred to simply as “medication”). The requestor can be the patient himself or herself, a self-insured entity, a third party administrator (TPA), a physician, a pharmacist, a nurse and the like. In addition, the requestor may or may not be an entity that is responsible for paying for the patient's medication.

The information-gathering template can be in the form of an HTML web page that is available or accessible through the Internet and has one or more input fields where information such as medication, a requestor's name, a requestor's contact information, a physician's name, a physician's contact information and the like can be entered. Also included is a system administrator module that can receive the information input into the information-gathering template and thereafter instruct a search engine to search a database, the database containing at least a list of medications and their respective cost. In some instances, the database has files with information on prescription medications including a class of a given medication/drug, a standard dosage per time and a cost per standard dosage. The database can be continually and/or periodically updated as drug manufacturers develop new drugs, change pricing of drugs and/or when new generic drugs become available.

The system administrator module can instruct the search engine to search the database for a cost associated with the medication and for any therapeutic equivalents to the medication and their respective cost. Thereafter, the search engine executes such a search and delivers any results and/or findings back to the system administrator module which can then make a determination as to whether or not there would be any cost savings in providing one of the therapeutic equivalents to the patient as a substitute for the original medication. In some instances, the system administrator module makes such a determination by: (1) taking the current dosage of the patient's medication and calculating a cost for the patient's medication over a given period of time; (2) calculating an equivalent dosage of an identified therapeutic equivalent(s); (3) calculating a cost for the identified therapeutic equivalent(s) for die equivalent dosage for the same given period of time; and then (4) calculating a difference in the cost between the patient's medication and the therapeutic equivalent(s), for the same given period of time. After making such a determination, the system administrator module can create a report containing the difference in cost between the patient's medication and the therapeutic equivalent(s) and instruct a message delivery module to deliver the report to the requestor and to the physician. Thereafter, the message delivery module delivers the report information as instructed.

A process for providing the requestor and the physician with information on available cost savings for therapeutic equivalents to the patient's medication is also disclosed. The process includes providing the computer software system described above and logging onto the system. Logging onto the computer software system may be accomplished by simply opening/entering a website, or in the alternative, by opening/entering the website and providing required login information such as username, password, access code and the like. After the computer software system has been logged onto, the requester enters a medication into the appropriate input field of the information-gathering template and requests a report comparing the cost of the medication to a cost of any therapeutic equivalents identified in the database. In addition, the requester can enter the patient's name, the patient's physician's name, their respective contact information and the like. Thereafter, the computer software system operates as disclosed above.

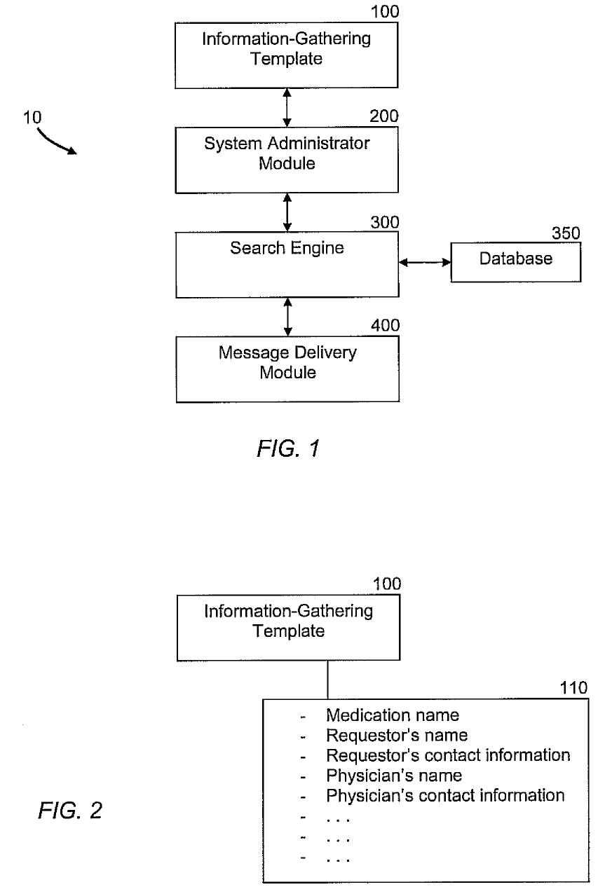

Turning now to FIG. 1, an embodiment of a computer software system is illustratively shown at reference numeral 10. The computer software system 10 can include an information-gathering template 100, a system administrator module 200, a search engine 300, a database 350 and a message delivery module 400. The information-gathering template 100 can be in the form of a web-based HTML screen that is accessible by the requester and has at least an input field for accepting the name of a medication. In addition, as shown in FIG. 2 at reference numeral 110, the information-gathering template can have input fields for accepting other information such as the requestor's name, requestor's contact information, the physician's name associated with a patient, the physician's contact information and the like. After relevant information has been entered into the information-gathering template 100, such information is sent to the system administrator module 200.

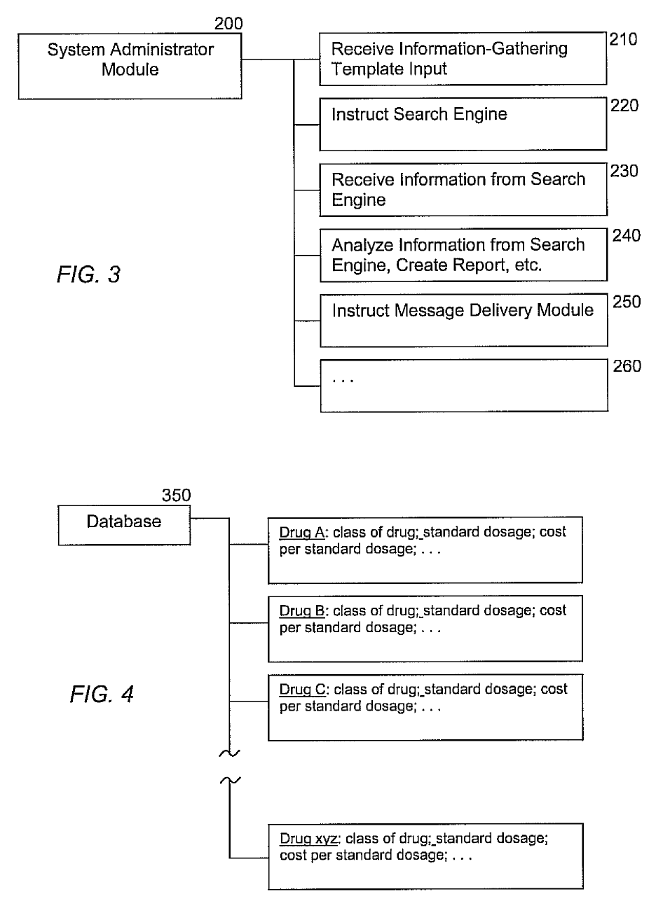

Looking specifically at FIG. 3, the system administrator module 200 can perform a variety of tasks such as receive the information-gathering template input at step 210, instruct the search engine 300 at step 220, receive information from the search engine 300 at step 230, analyze information received from the search engine 300, create reports, etc. at step 240, instruct the message delivery module 400 at step 250 and other desired tasks not specifically mentioned but known to one skilled in the art at step 260. As noted above, the system administrator module 200 can instruct the search engine 300 to search for a cost for a particular medication and any therapeutic equivalents to the medication. For the purposes of the present invention, the term “therapeutic equivalent” is defined as a separate medication, vitamin, homeopathic remedy and the like that has or exhibits the same healing characteristics and/or healing power as the medication at issue and may or may not be a medication that is in the same class of drug as a prescription medication that is input into the information-gathering template 100.

Thereafter, the search engine 300 can search the database 350 for the cost of the medication and for any therapeutic equivalents that may be available. As shown in FIG. 4, the database 350 can include files on prescription medications, also referred to as “drugs,” that include information such as the class of the drug, the standard dosage of the drug and the cost per standard dosage of the drug. Upon obtaining any such results, the search engine 300 returns such information to the system administrator module 200 which can determine and/or analyze whether or not any lower cost alternatives are available for the input medication. In addition, the system administrator module 200 can prepare a report that summarizes and/or details any cost savings for using a therapeutic equivalent over an extended period of time and then instruct the message delivery module 400 to deliver the report to the requester and the physician.

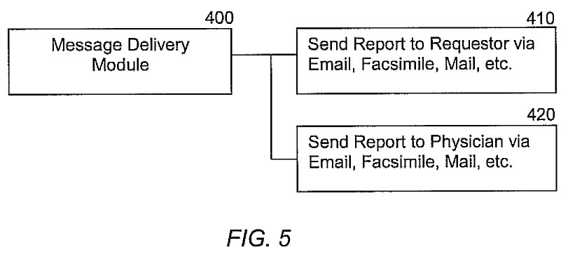

Turning to FIG. 5, the message delivery module 400 can send the report to the requester by email, facsimile, regular mail, etc. at step 410 and also send such a report to the physician at step 420. It is appreciated that the email address, facsimile number, regular mail address and the like can be provided by the requester using the information-gathering template 100, or in the alternative, contact information for certain entities can be provided by a contact information database. For example, contact information for known physicians, employees, etc., can be stored in a database that is part of the computer software system, such that the email address, facsimile number and/or regular mail address for a requester or physician would not have to be entered into the information-gathering template 100. After the requester has received such a report, the requester can contact the physician who has also received such a report and discuss whether or not it is appropriate to use one of the therapeutic equivalents that has been identified. In the alternative, if a patient is too embarrassed to discuss medication alternatives with their physician, the physician having the report can suggest one of the therapeutic equivalents on their own initiative. It is appreciated that the report can have a statement requesting the physician to mention and/or discuss the use of a therapeutic equivalent to the patient when the physician sees the patient during a subsequent doctor's visit. The report can also include a statement requesting the physician to call the patient and discuss the use of a therapeutic equivalent.

It is appreciated that such a system enhances an information exchange between a patient and the patient's treating physician by providing a report to both. With the report sent to both individuals, the patient is more likely to discuss therapeutic equivalents with their physician and the physician is more likely to initiate a conversation on the use of lower cost therapeutic equivalents with the patient. Such a system thus affords a patient to have more control of their health care and save money by using a therapeutic equivalent to a costly medication.

An embodiment of a process wherein a requestor uses the computer software system to provide information on available cost savings for therapeutic equivalents to a patient's medication includes providing a computer software system as detailed above. In addition, the requester logs onto the computer software system by entering a website that allows access to the computer software system and then further allows access to an HTML web page that includes the information-gathering template. After viewing the information-gathering template, the requestor enters relevant information such as the name of the medication at interest, the patient's name, the physician's name and the like. Thereafter, the requester can request an inquiry for a cost comparison between the medication of interest and any therapeutic equivalents to the medication within the database.

Upon receiving such a request, the system administrator module instructs the search engine to search the database and identify a cost associated with the input medication, search the database and identify any therapeutic equivalents to the medication name and send the cost associated with the medication name and any identified therapeutic equivalents with their respective cost back to the system administrator module. The search engine performs its instructed task and upon receiving the results and/or findings obtained by the search engine from the database, the system administrator module analyzes and/or makes a determination as to whether or not the respective cost of any of the therapeutic equivalents is less than the cost of the input medication. In addition, the system administrator module can calculate a difference in cost between the input medication and any therapeutic equivalents for an extended period of time and create a report that summarizes and/or details such differences in cost. After such a report has been created, the system administrator module can instruct the message delivery module to send the report to the requestor and the physician. After the report has been sent, the process includes the requester and the physician receiving the report from the computer software system.

In this manner, a computer software system is provided that can supply a requester and a physician with information on available cost savings for therapeutic equivalents to a patient's medication. In order to better illustrate and yet not limit the invention in any way, examples are provided below wherein cost savings associated with therapeutic equivalents to a particular medication are provided.

### EXAMPLE 1

The medication Altace having a dosage of 5 milligrams taken 1 tablet daily was input into the information-gathering template with a request for its cost and any therapeutic equivalents with their respective cost submitted. The cost for Altace for a 90-day prescription was $114, the therapeutic equivalent of lisinopril had a cost of $12 for 90 days and the therapeutic equivalent enalapril had a cost also of $12 for 90 days. As such, the savings for a 90-day period was $102 with an estimated annual savings of $408.

It is appreciated that an email, fax and/or letter could have been sent to the patient's physician with the physician making the final decision as to whether or not one of the therapeutic equivalents would be suitable for the individual patient. It is important to note that the computer software system leaves the final decision as whether or not to use a therapeutic equivalent up to the physician. The physician is best able to determine whether one of the therapeutic equivalents would be suitable for the individual patient. As such, the pharmacy, a pharmacist, a nurse, an insurance company, and the like do not make such a decision.

### EXAMPLE 2

The medication Paxil with a dosage of 20 milligrams taken 1 tablet daily was entered into the information-gathering template. Thereafter, a request for any therapeutic equivalents and their respective cost was submitted by the system administrator module to the search engine. The search engine upon searching the database returned potential cost savings for 3 therapeutic equivalents, in particular fluoxetine, paroxetine and sertraline. The annual savings for using fluoxetine instead of Paxil was $1,155, for using paroxetine $1,103 and for using sertraline $997. In addition, a report in the form a letter was faxed to the patient's physician such that the physician could make the final decision as to whether or not one of the therapeutic equivalents would be suitable for the patient.

The invention is not restricted to the illustrative examples described above. The examples are not intended as limitations on the scope of the invention. Methods, apparatus, and the like described herein are exemplary and not intended as limitations on the scope of the invention. Changes therein and other uses will occur to those skilled in the art. As such, the scope of the invention is defined by the scope of the claims.

We claim:

1. A computer software system for providing a requestor and a physician with information on available cost savings for therapeutic equivalents to a patient's medication, said computer system comprising:
an information-gathering template, said information-gathering template accessible by a requestor that is paying for the patient's medication and having an input field for accepting a medication name;
a system administrator module that receives said medication name from said information-gathering template;
a search engine that receives instruction from said system administrator module;
a database containing a list of medication names and their respective cost; and
a message delivery module;
said system administrator module instructing said search engine to search said database and identify a cost associated with said medication name, search said database and identify any therapeutic equivalents to said medication name, and send said cost associated with said medication name, any identified therapeutic equivalents and their respective cost back to said system administrator module;
said search engine searching said database and identifying said cost associated with said medication name, identifying any said therapeutic equivalents, said search engine also sending said cost associated with said medication name and any identified therapeutic equivalents and their respective cost back to said system administrator module;
said system administrator module making a determination as to whether or not said respective cost of any said therapeutic equivalents is less than said cost of said medication name, said system administrator creating a report as a function of said determination and instructing said message delivery module to deliver said report to the requestor and the physician;
said message delivery module delivering said report to the requester and the physician.

2. The computer software system of claim 1, wherein said information-gathering template has an input field for accepting the physician's name and facsimile number.

3. The computer software system of claim 1, wherein said information-gathering template has an input field for accepting the physician's name and email address.

4. The computer software system of claim 1, wherein said information-gathering template has an input field for accepting the requestor's name and email address.

5. The computer software system of claim 1, wherein said report is in the form of a printable HTML web page.

6. The computer software system of claim 1, wherein said report is in the form of an email.

7. The computer software system of claim 1, wherein said report is in the form of a facsimile.

8. The computer software system of claim 1, wherein said information-gathering template is a web-based HTML screen.

9. A process for providing a requestor and a physician with information on available cost savings for therapeutic equivalents to a patient's medication, the process comprising:
providing a computer software system having:
an information-gathering template, said information-gathering template accessible by a requester that is paying for the patient's medication and having an input field for accepting a medication name;
a system administrator module that receives said medication name from said information-gathering template;
a search engine that receives instruction from said system administrator module;
a database containing a list of medication names and their respective cost; and
a message delivery module;
logging onto the computer software system;
entering a patient name, a medication name for the patient and physician's name for the patient into the information-gathering template;
requesting a report comparing the cost of the medication name to a cost of any therapeutic equivalents identified in the database;
the system administrator module instructing the search engine to search the database and identify a cost associated with the medication name, search the database and identify any therapeutic equivalents to the medication name, and send the cost associated with the medication name and any identified therapeutic equivalents with their respective cost back to the system administrator module;
the search engine searching the database and identifying the cost associated with the medication name, identifying any the therapeutic equivalents, the search engine also sending the cost associated with the medication name and any identified therapeutic equivalents with their respective cost back to the system administrator module;
the system administrator module making a determination as to whether or not the respective cost of any of the therapeutic equivalents is less than the cost of the medication name and calculating a difference in cost between the medication name and any therapeutic equivalents for an extended period of time, the system administrator also creating a report illustrating any difference in cost and instructing the message delivery module to deliver the report to the requester and the physician;
the message delivery module delivering the report to the requestor and the physician; and
receiving a report from the computer software system.

10. The process of claim 9, wherein the information-gathering template has an input field for accepting the physician's name and facsimile number.

11. The process of claim 9, wherein the information-gathering template has an input field for accepting the physician's name and email address.

12. The process of claim 9, wherein the information-gathering template has an input field for accepting the requestor's name and email address.

13. The process of claim 9, wherein the requestor is the patient.

14. The process of claim 9, wherein the requestor is a self-insured entity.

15. The process of claim 9, wherein the requester is a third party administrator.

16. The process of claim 9, wherein the information-gathering template is a web-based HTML screen.

17. The process of claim 9, wherein the report is in the form of a printable HTML web page.

18. The process of claim 9, wherein the report is in he form of an email sent to the physician.

19. The process of claim 9, wherein the report is in the form of a facsimile sent to the physician.
